(19) United States
(12) Patent Application Publication
(10) Pub. No.: US 2015/0227472 A1
(43) Pub. Date: Aug. 13, 2015

(54) MEMORY SYSTEM, CONTROLLER, AND METHOD

(71) Applicant: Kabushiki Kaisha Toshiba, Minato-ku (JP)

(72) Inventor: Kiyotaka MATSUO, Fujisawa (JP)

(73) Assignee: Kabushiki Kaisha Toshiba, Minato-ku (JP)

(21) Appl. No.: 14/455,151

(22) Filed: Aug. 8, 2014

Related U.S. Application Data
(60) Provisional application No. 61/937,888, filed on Feb. 10, 2014.

(51) Int. Cl. G06F 12/14

(52) U.S. Cl. CPC G06F 12/1408; G06F 2212/1052

(57) ABSTRACT

According to one embodiment, a memory system includes a controller. The controller includes a key output unit, a plurality of cores, a first sequencer, and a second sequencer. The first sequencer sequentially acquires first data as second data items and third data. The first sequencer causes the key output unit to output a first key and distributes the plurality of second data items which are sequentially acquired to the plurality of cores. The first sequencer distributes the third data to the same first core as that to which fourth data that is acquired immediately before the third data is distributed. Before the encryption of the third data is completed, the first sequencer starts acquiring fifth data following the first data and causes the key output unit to output a first key for encrypting the fifth data. The second sequencer collects data encrypted by each of the plurality of cores.

### CROSS-REFERENCE TO RELATED APPLICATIONS

This application is based upon and claims the benefit of priority from U.S. Provisional Application No. 61/937,888, filed on Feb. 10, 2014; the entire contents of which are incorporated herein by reference.

### FIELD

Embodiments described herein relate generally to a memory system, a controller, and a method.

### BACKGROUND

In evaluation of the performance of a solid-state drive (SSD), the data transmission rate between the SSD and a host is an important factor. In a self-encrypting drive (SED) which encrypts data using a method based on the Advanced Encryption Standard (AES), a process of encrypting and decrypting data on the basis of the AES happens and a delay occurs in data transmission due to this process. It is necessary to reduce the delay in order to increase the data transmission rate with the host.

### BRIEF DESCRIPTION OF THE DRAWINGS

FIG. 1 is a diagram illustrating the structure of a memory system according to a first embodiment;

FIG. 2 is a diagram illustrating the structure of a first AES unit;

FIG. 3 is a timing chart illustrating the operation of the first AES unit according to the first embodiment;

FIG. 4 is a diagram illustrating the structure of a second ABS unit according to the first embodiment;

FIG. 5 is a diagram illustrating the structure of a first AES unit according to a second embodiment;

FIG. 6 is a diagram illustrating the structure of a second AES unit according to the second embodiment; and

FIG. 7 is a timing chart illustrating the operation of the first AES unit according to the second embodiment.

### DETAILED DESCRIPTION

In general, according to one embodiment, a memory system which can be connected to a host includes a non-volatile memory and a controller that controls the non-volatile memory. The controller includes a first conversion unit. The first conversion unit includes a first key output unit, a plurality of first cores that perform encryption, a first sequencer, and a second sequencer. The first sequencer sequentially acquires first data as a plurality of second data items with a first size and third data. The first data is data received from the host. The third data has a second size less than the first size and being acquired last. The first sequencer causes the first key output unit to output a first key for encrypting the first data. The first sequencer distributes the plurality of second data items sequentially to the plurality of first cores. The first sequencer distributes the third data to the same first core as that to which fourth data is distributed. The fourth data is data acquired immediately before the third data. The first sequencer, before the encryption of the third data is completed, starts acquiring fifth data which is received from the host following the first data, and causes the first key output unit to output a first key for encrypting the fifth data. The second sequencer collects data encrypted by each of the plurality of first cores. The controller transmits the data collected by the second sequencer to the non-volatile memory.

Exemplary embodiments of a controller, and a method will be explained below in detail with reference to the accompanying drawings. The present invention is not limited to the following embodiments.

In this embodiment, data is encrypted and decrypted by an AES method. However, the encryption/decryption method is not limited to the AES.

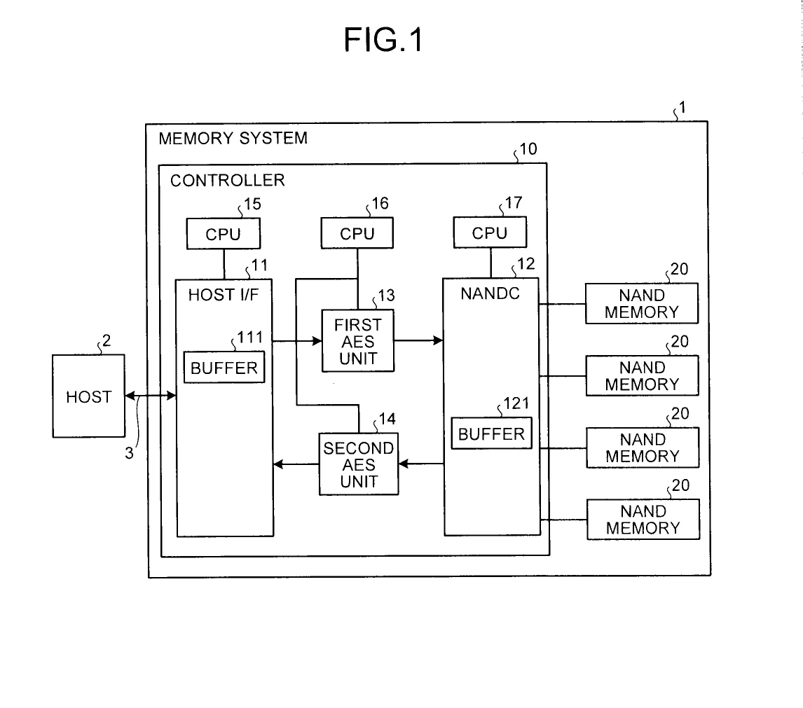

FIG. 1 is a diagram illustrating the structure of a memory system according to a first embodiment. A memory system 1 is connected to a host 2 through a communication path 3. The memory system 1 can function as an external storage device of the host 2. The host 2 issues an access command (a read command and a write command) to the memory system 1. The memory system 1 can store data in response to the write command or can output data in response to the read command. The access command includes address information for designating a storage position of data. The address information is described in any pattern. The address information is described by, for example, a logical block addressing (LBA) method. The communication path 3 is based on any standard. For example, Serial Advanced Technology Attachment (SATA) or Serial Attached SCSI (SAS) can be used as the standard of the communication path 3.

The memory system 1 includes a controller 10 and a memory chip (NAND memory) 20 including a NAND flash memory. An arbitrary number of NAND memories 20 are provided in the memory system 1. The plurality of NAND memories 20 and the controller 10 have any connection relation therebetween. In the example illustrated in FIG. 1, the memory system 1 includes four NAND memories 20 and each NAND memory 20 is connected to the controller 10.

The NAND memory 20 functions as a storage which stores data from the host 2. In addition, a storage device other than the NAND flash memory can be used as the storage. For example, a magnetoresistive random access memory (MRAM), a resistance random access memory (ReRAM), or a magnetic disk can be used as the storage. The memory system 1 includes an arbitrary number of NAND memories 20.

The controller 10 controls each NAND memory 20. The controller 10 transmits data between the host 2 and each NAND memory 20 as a part of the control. Specifically, the controller 10 stores data transmitted from the host 2 in each NAND memory 20, or it reads data from each NAND memory 20 and transmits the read data to the host 2.

The controller 10 includes a host interface (host I/F) 11, a NAND controller (NANDC) 12, a first AES unit (first conversion unit) 13, a second AES unit (second conversion unit) 14, a central processing unit (CPU) 15, a CPU 16, and a CPU 17.

The host I/F 11 communicates with the host 2 through the communication path 3 under the control of the CPU 15. The host I/F 11 can receive data transmitted from the host 2 to an embedded buffer 111. In addition, the host I/F 11 can transmit, to the host 2, data which has been requested by a read command from the host 2 and then read from the NAND memory 20.

The first AES unit 13 reads data from the buffer 111 and encrypts the read data using an encryption method based on the AES. The first AES unit 13 transmits the encrypted data to the NANDC 12.

The NANDC 12 transmits the encrypted data received from the first AES unit 13 to each NAND memory 20 under the control of the CPU 17. In addition, the NANDC 12 reads data which is requested by the read command from the host 2 from each NAND memory 20 and stores the read data in an embedded buffer 121. The data which is read from each NAND memory 20 and then stored in the buffer 121 is encrypted data.

The second AES unit 14 reads data from the buffer 121 and decrypts the read data. The second AES unit 14 transmits the decrypted data to the host I/F 11. The host I/F 11 transmits the decrypted data transmitted from the second AES unit 14 to the host 2.

The CPU 16 sets the operation mode of the AES units 13 and 14 while the AES units 13 and 14 do not operate and sets a key for encryption and decryption. In the AES, a key common to encryption and decryption is used. The key for encryption and decryption is referred to as an encryption key.

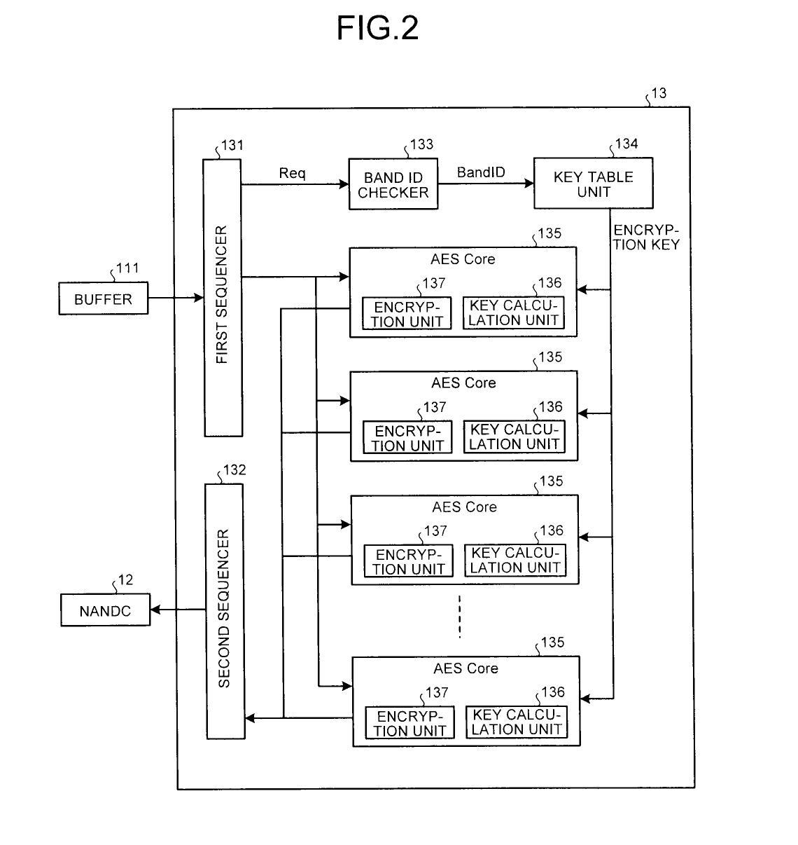

FIG. 2 is a diagram illustrating the structure of the first AES unit 13. The first AES unit 13 includes a first sequencer 131, a second sequencer 132, a band ID checker 133, a key table unit 134, and a plurality of AES cores 135. Each AES core 135 includes a key calculation unit 136 and an encryption unit 137.

The process of each AES core 135 requires a predetermined time corresponding to, for example, a size of the encryption key. In order to reduce the time required for the process of each AES core 135 as much as possible, the first sequencer 131 divides the data read from the buffer 111 into a plurality of unit data items and distributes the unit data items to different AES cores 135. The second sequencer 132 collects the encrypted unit data output from each AES core 135 and sequentially transmits the collected encrypted unit data to the NANDC 12. Each unit data item has, for example, a size which can be transmitted by a clock signal of a predetermined cycle (for example, one cycle).

It is assumed that a header is given to data (sector data) of unit, which is called a sector, and each sector data is stored in the buffer 111. The sector data is larger than the unit data. The header includes LBA indicating the initial address of the storage position of the sector data.

When the header is read from the buffer 111, the first sequencer 131 extracts address information included in the header. Then, the first sequencer 131 inputs the extracted address information and a band ID search request (Req) to the band ID checker 133.

The band ID checker 133 searches for a band ID in response to the band ID search request and outputs a found band ID. The band ID is information which is used as a search key that is used by the key table unit 134 to search for the encryption key. It is assumed that an address space is divided into a plurality of sections and different band ID for every section is set in the band ID checker 133. That is, the band ID checker 133 determines the section including the address information in the band ID search request and inputs the band ID corresponding to the determined section to the key table unit 134.

The key table unit 134 stores the encryption key for each band ID in advance. The key table unit 134 searches for the encryption key using the band ID input from the band ID checker 133 as a search key and commonly inputs a found encryption key to each AES core 135.

In each AES core 135, the key calculation unit 136 expands the encryption key input from the key table unit 134. The key calculation unit 136 inputs the expanded encryption key (expanded key) to the encryption unit 137.

The encryption unit 137 encrypts an initialization vector using the expanded key input from the key calculation unit 136. The initialization vector is set to the encryption unit 137 in advance. The encryption unit 137 encrypts the unit data input from the first sequencer 131 using the encrypted initialization vector. The encrypted unit data is collected by the second sequencer 132.

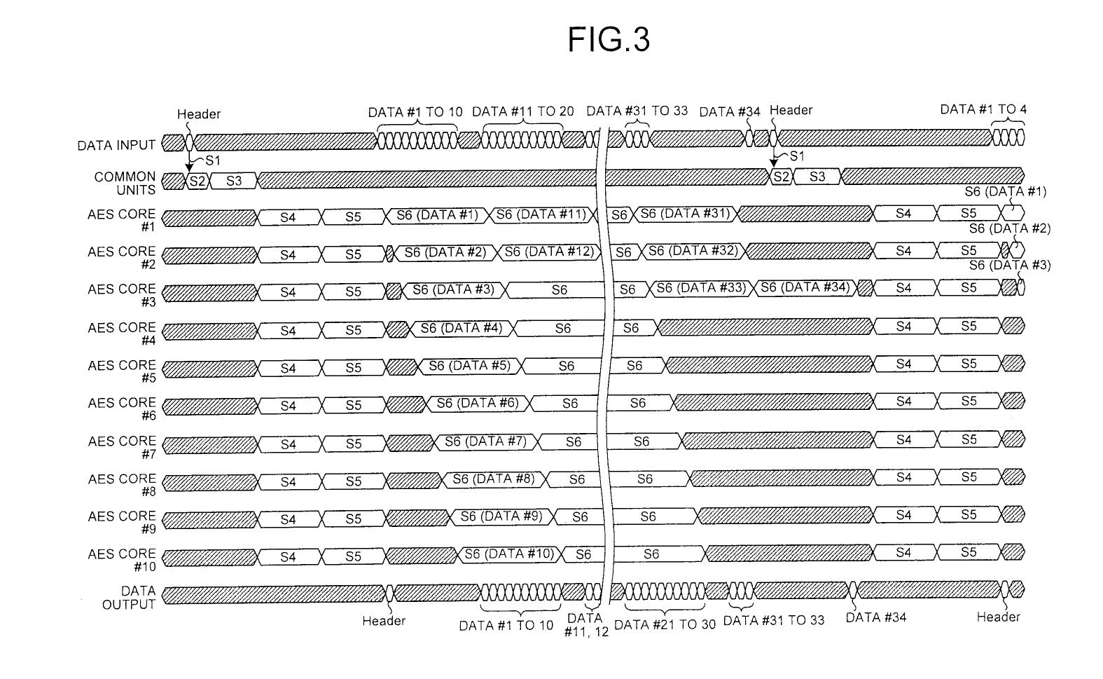

FIG. 3 is a timing chart illustrating the operation of the first AES unit 13 according to the first embodiment. In FIG. 3, a hatched portion indicates an idle state. The uppermost timing chart indicates the data input operation of the first sequencer 131 acquiring data from the buffer 111. The second timing chart from the top indicates the operation of common units. The common units mean the band ID checker 133 and the key table unit 134. The third to twelfth timing charts from the top indicate the operation of each AES core 135. The lowest timing chart indicates the operation of the second sequencer 132 outputting data to the NANDC 12.

In some cases, 10 AES cores 135 are identified by numbers, as AES core #1 to AES core #10. In addition, in some cases, the unit data items forming the sector data are identified by numbers, as Data #1 and Data #2. In the example illustrated in FIG. 3, it is assumed that the first sector data includes a header and Data #1 to Data #34.

First, the first sequencer 131 acquires the header from the buffer 111 and inputs the band ID search request to the band ID checker 133 (S1). The band ID checker 133 searches for the band ID and inputs a found band ID to the key table unit 134 (S2). The key table unit 134 searches for the encryption key corresponding to the input band ID and commonly inputs a found encryption key to AES cores #1 to #10 (S3).

In each of AES cores #1 to #10, the key calculation unit 136 expands the input encryption key (S4). The encryption unit 137 encrypts the initialization vector using the expanded key (S5).

Since the encryption key is input to AES cores #1 to #10 at the same time, the process of S5 ends in AES cores #1 to #10 at the same time. The first sequencer 131 acquires Data #1 from the buffer 111 before the process of S5 ends in AES core #1. Then, when the process of S5 ends in AES core #1, the first sequencer 131 inputs Data #1 to AES core #1. The first sequencer 131 acquires Data #2 from the buffer 111 at the same time as Data #1 is input to AES core #1. Then, after inputting Data #1 to AES core #1, the first sequencer 131 acquires Data #3 from the buffer 111 at the same time as Data #2 is input to AES core #2. As such, the first sequencer 131 sequentially acquires the unit data one by one and sequentially distributes the acquired unit data to each AES core 135 one by one.

After the process of S5 ends, each AES core 135 waits until the unit data is input. When the unit data is input, each AES core 135 encrypts the input unit data using the initialization vector encrypted in the process of S5 (S6). Since the unit data is sequentially input to AES core #1, AES core #2, AES core #3, . . . in this order, the encryption of the unit data is completed in the order of AES core #1, AES core #2, AES core #3, . . . .

The header is input from the first sequencer 131 to the second sequencer 132 at the time when the process of S6 starts in AES core #1. The second sequencer 132 outputs the input header to the NANDC 12, without any change. In addition, the second sequencer 132 acquires the encrypted unit data from the AES core 135 which has completed encryption and sequentially outputs the acquired unit data to the NANDC 12.

At the time when the first sequencer 131 ends the acquisition of Data #1 to Data #10, AES cores #1 to #10 are performing the process of S6. AES cores #1 to #10 complete the process of S6 in the order in which the unit data is input. When AES core #1 completes the process of S6, the first sequencer 131 inputs Data #11, which is unit data following Data #10, to AES core #1. Then, the first sequencer 131 inputs Data #12 to Data #20 to AES cores #2 to #10. Each AES core 135 performs the process of S6 for the input unit data and the second sequencer 132 collects the encrypted unit data and sequentially outputs the encrypted unit data to the NANDC 12.

In the AES, when the last unit data (Data #34) among the unit data items forming the sector data is less than a predetermined size (for example, a size which can be transmitted by one cycle of clock signal), it is determined to be input to the same AES core 135 as that to which the previously encrypted unit data (Data #33) is input. Here, since Data #33 is encrypted in AES core #3, Data #34 is input to AES core #3. The first sequencer 131 waits until the encryption of Data #33 in AES core #3 is completed. When the encryption of Data #33 in AES core #3 is completed, the first sequencer 131 inputs Data #34 to AES core #3. AES core #3 encrypts Data #34 after the encryption of Data #33 is completed.

In the first embodiment, after the acquisition of all unit data items of one sector data item is completed and before the encryption of all of the acquired data items is completed, the first sequencer 131 acquires the header of the next sector data. That is, in the example illustrated in FIG. 3, after Data #34 is acquired and before the encryption of Data #34 is completed, the first sequencer 131 acquires the header of the next sector data. In this way, the common units can start the process of S2 for the next sector data before the encryption of Data #34 is completed. In addition, the common unit can start the process of S3 immediately after the process of S2 is completed. As such, at least a portion of the delay until the encryption of Data #34 is completed is hidden by the process for the next sector. In the example illustrated in FIG. 3, the first sequencer 131 is changed to an idle state after acquiring Data #34. However, the first sequencer 131 may acquire the header of the next sector data, without being changed to the idle state after acquiring Data #34.

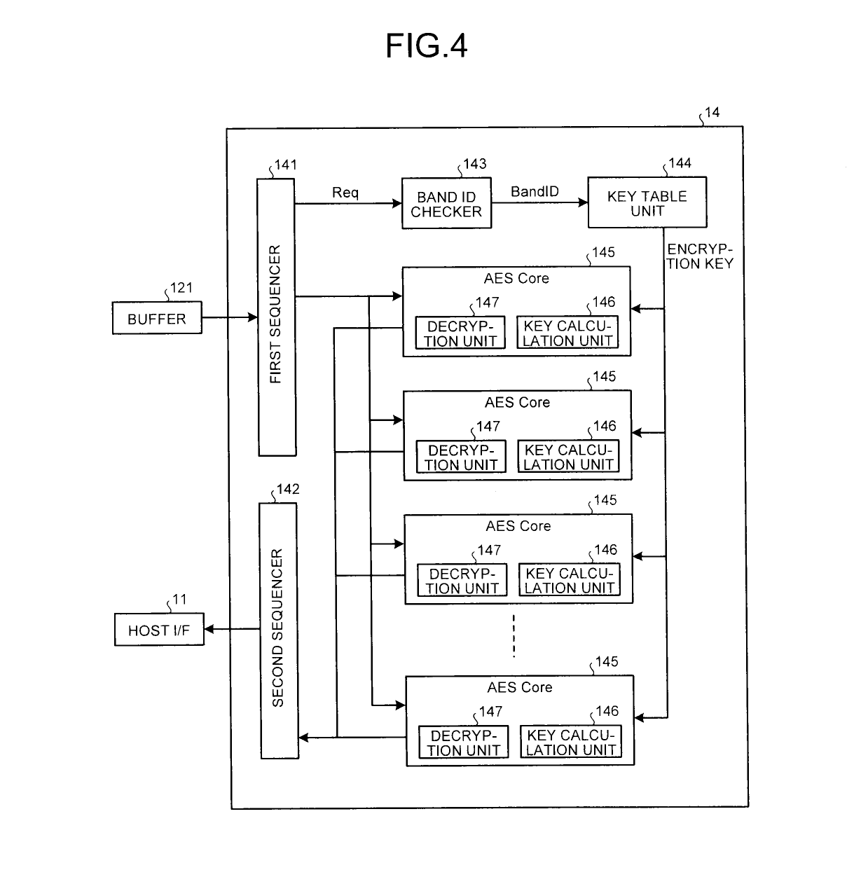

FIG. 4 is a diagram illustrating the structure the second AES unit 14 according to the first embodiment. The second AES unit 14 includes a first sequencer 141, a second sequencer 142, a band ID checker 143, a key table unit 144, and a plurality of AES cores 145. Each AES core 145 includes a key calculation unit 146 which calculates an encryption key and a decryption unit 147 which decrypts the encrypted data.

The encrypted data is read from each NAND memory 20 to the buffer 121 for each sector data item. The first sequencer 141 acquires the header from the head of the sector data stored in the buffer 121 and acquires the sector data for each unit data item. Similarly to the first sequencer 131, the first sequencer 141 distributes a plurality of unit data items forming the sector data to the plurality of AES cores 145.

When reading the header from the buffer 121, the first sequencer 141 extracts address information included in the header. Then, the first sequencer 141 inputs the extracted address information and the band ID search request (Req) to the band ID checker 143.

The band ID checker 143 has the same function as the band ID checker 133 and the key table unit 144 has the same function as the key table unit 134. That is, the band ID checker 143 searches for a band ID in response to the band ID search request and inputs a found band ID to the key table unit 144. The key table unit 144 searches for an encryption key using the band ID input from the band ID checker 143 as a search key and commonly inputs a found encryption key to each AES core 145.

The key calculation unit 146 has the same function as the key calculation unit 136. The key calculation unit 146 expands the encryption key input from the key table unit 144. The key calculation unit 146 inputs the expanded key to the decryption unit 147.

The decryption unit 147 encrypts the initialization vector using the expanded key input from the key calculation unit 146. The initialization vector is set to the decryption unit 147 in advance. The decryption unit 147 decrypts the unit data input from the first sequencer 141 using the encrypted initialization vector. The decrypted unit data is collected by the second sequencer 142.

The second sequencer 142 collects the unit data decrypted in each AES core 145 and sequentially inputs the plurality of collected unit data items to the host I/F 11.

The operation and operation timing of the first sequencer 141, the second sequencer 142, the band ID checker 143, the key table unit 144, the key calculation unit 146, and the decryption unit 147 are the same as the operation and operation timing of the first sequencer 131, the second sequencer 132, the band ID checker 133, the key table unit 134, the key calculation unit 136, and the encryption unit 137 illustrated in FIG. 3 except that the encryption unit 137 encrypts the unit data and the decryption unit 147 decrypts the encrypted unit data. That is, in S6, the encryption unit 137 encrypts the unit data and the decryption unit 147 decrypts the unit data.

The encrypted unit data items forming the sector data are decrypted in parallel by the plurality of AES cores 145. After the acquisition of all unit data items of one sector data item is completed and before the decryption of all of the acquired data items is completed, the first sequencer 141 acquires the header of the next sector data from the buffer 121. Then, the first sequencer 141 inputs the band ID search request to the band ID checker 143. The band ID checker 143 searches for the band ID. In this way, at least a portion of the delay until the decryption of the last unit data in one sector data item is completed is hidden by a process for the next sector.

As such, according to the first embodiment, after the acquisition of the last unit data in one sector data item is completed and before the encryption of the last unit data is completed, the first sequencer 131 acquires the header of the next sector data. Before the encryption of the last unit data in one sector data item is completed, the common units can start the acquisition of the unit data and the output of the encryption key for the next sector data. In this way, the time from the completion of the encryption of one sector data item to the start of the encryption of the next sector data is reduced. Therefore, latency for data transmission is reduced.

Similarly, after the acquisition of the last unit data in one sector data item is completed and before the decryption of the last unit data is completed, the first sequencer 141 acquires the header of the next sector data. Before the decryption of the last unit data among all of the acquired unit data items is completed, the common units can start the acquisition of the unit data and the output of the encryption key for the next sector data. In this way, the time from the completion of the decryption of one sector data item to the start of the decryption of the next sector data is reduced. Therefore, latency for data transmission is reduced.

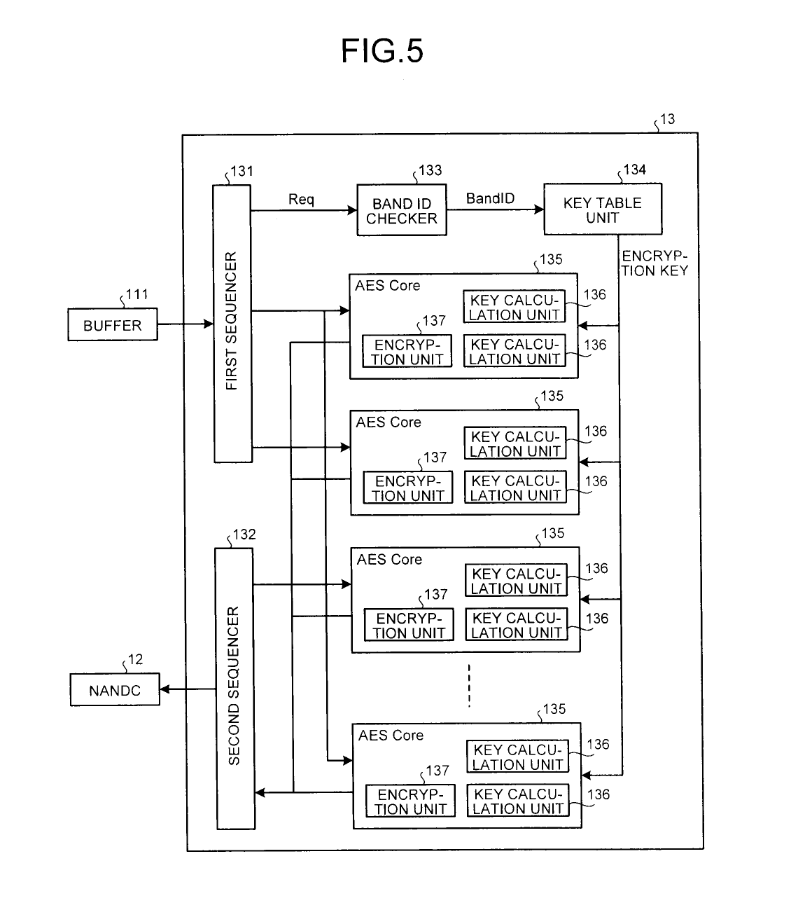

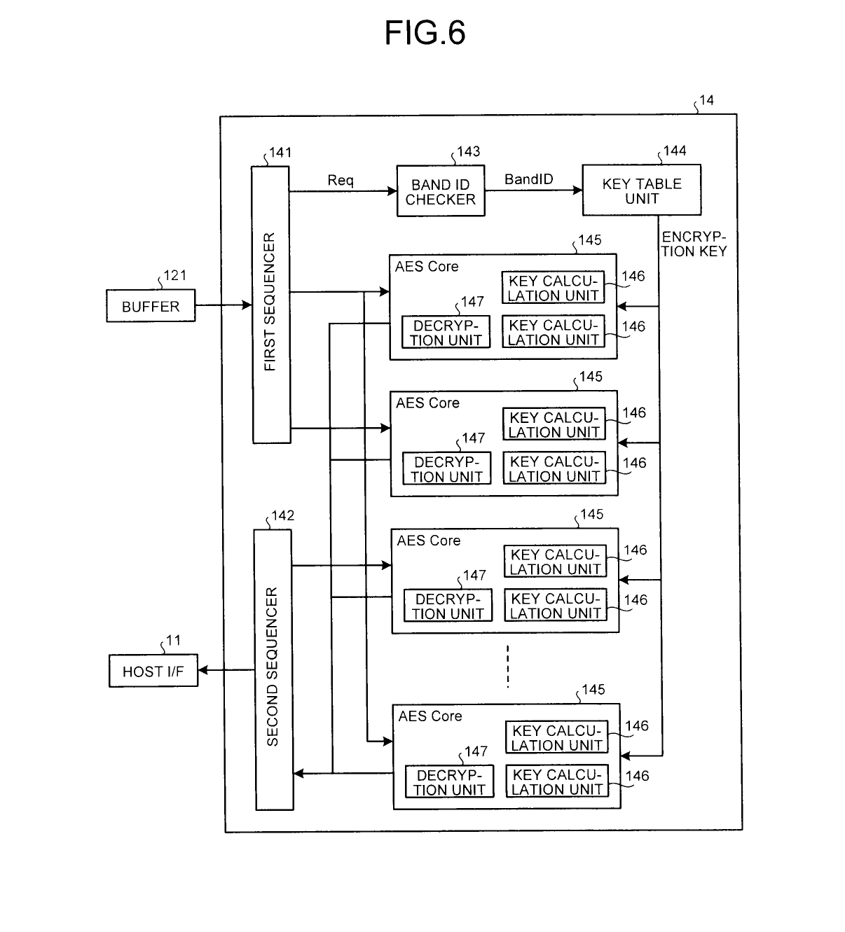

FIG. 5 is a diagram illustrating the structure of a first AES unit according to a second embodiment and FIG. 6 is a diagram illustrating the structure of a second AES unit according to the second embodiment. In the second embodiment, key calculation units 136 and 146 are multiplexed. In this embodiment, each AES core 135 provided in the first AES unit 13 includes two key calculation units 136 and each AES core 145 provided in the second AES unit 14 includes two key calculation units 146.

The two key calculation units 136 operate alternately. For example, for an odd-numbered sector (that is, sector data in which address information has an odd value), one of the two key calculation units 136 expands an encryption key. For an even-numbered sector (that is, sector data in which address information has an even value), the other of the two key calculation units 136 expands the encryption key. Similarly, the two key calculation units 146 operate alternately.

In some cases, the two key calculation units 136 are distinguished from each other as key calculation unit #1 and key calculation unit #2.

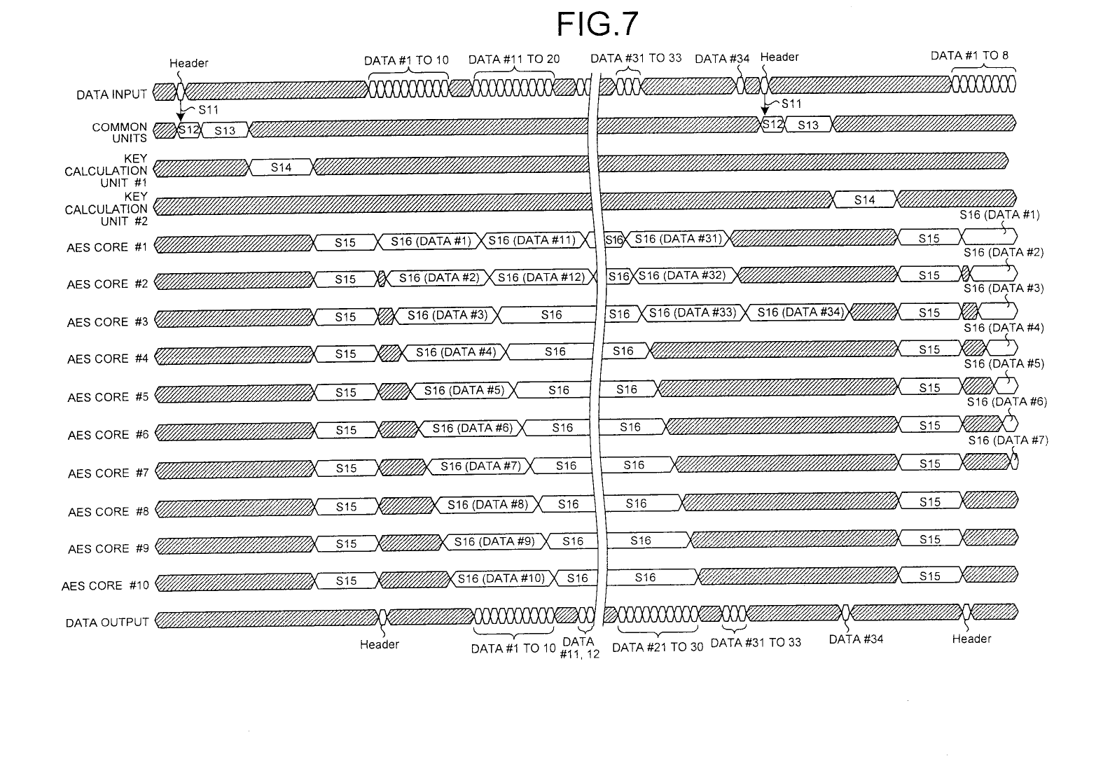

FIG. 7 is a timing chart illustrating the operation of the first AES unit 13 according to the second embodiment. In FIG. 7, the uppermost timing chart indicates the operation of a first sequencer 131 acquiring data from a buffer 111. The second timing chart from the top indicates the operation of common units. The common units are a band ID checker 133 and a key table unit 134. The third timing chart from the top indicates the operation of key calculation unit #1 provided in each AES core 135. The fourth timing chart from the top indicates the operation of key calculation unit #2 provided in each AES core 135. The fifth to fourteenth timing charts from the top indicate the operation of an encryption unit 137 in each AES core 135. The lowest timing chart indicates the operation of a second sequencer 132 outputting data to a NANDC 12.

First, the first sequencer 131 acquires a header from the buffer 111 and outputs a band ID search request to the band ID checker 133 (S11). The band ID checker 133 searches for a band ID and inputs a found band ID to the key table unit 134 (S12). The key table unit 134 searches for an encryption key corresponding to the input band ID and commonly inputs a found encryption key to key calculation unit #1 in each of AES cores #1 to #10 (S13).

In each of AES cores #1 to #10, key calculation unit #1 expands the input encryption key (S14). The encryption unit 137 encrypts an initialization vector using the expanded key calculated in key calculation unit #1 (S15).

The first sequencer 131 acquires Data #1 from buffer 111 before the process of S15 ends in AES core #1. When the process of S15 ends in AES core #1, the first sequencer 131 inputs Data #1 to AES core #1. The first sequencer 131 acquires Data #2 from the buffer 111 at the same time as it inputs Data #1 to AES core #1. Then, after inputting Data #1 to AES core #1, the first sequencer 131 acquires Data #3 from the buffer 111 at the same time as it inputs Data #2 to AES core #2. As such, the first sequencer 131 sequentially acquires unit data one by one and sequentially distributes the acquired unit data one by one to each AES core 135.

After the process of S15 is completed, each AES core 135 waits until unit data is input. When unit data is input, each AES core 135 encrypts the input unit data using the initialization vector encrypted in S15 (S16). Since unit data is input to AES core #1, AES core #2, AES core #3, in the order, the encryption of the unit data is completed in the order of AES core #1, AES core #2, AES core #3, . . . .

The header is input from the first sequencer 131 to the second sequencer 132 at the time when the process of S16 starts in AES core #1. The second sequencer 132 outputs the input header to the NANDC 12 without any change. In addition, the second sequencer 132 acquires the encrypted unit data from the AES core 135 which has completed encryption and sequentially outputs the acquired unit data to the NANDC 12.

At the time when the first sequencer 131 ends the distribution of Data #1 to Data #10, AES cores #1 to #10 are performing the process of S16. AES cores #1 to #10 complete the process of S16 in the order in which the unit data is input. When AES core #1 completes the process of S16, the first sequencer 131 inputs Data #11, which is unit data following Data #10, to AES core #1. Then, the first sequencer 131 inputs Data #12 to Data #20 to AES cores #2 to #10. Each AES core 135 performs the process of S16 for the input unit data and the second sequencer 132 collects the encrypted unit data and sequentially outputs the encrypted unit data to the NANDC 12.

The first sequencer 131 waits until AES core #3 completes the encryption of Data #33, which is unit data immediately before Data #34 that is the last unit data of the sector data. When AES core #3 completes the encryption of Data #33, the first sequencer 131 inputs Data #34 to AES core #3. After completing the encryption of Data #33, AES core #3 encrypts Data #34.

Similarly to the first embodiment, after the acquisition of all unit data items in one sector data item is completed and before the encryption of all of the acquired unit data items is completed, the first sequencer 131 acquires the header of the next sector data. That is, after Data #34 is acquired and before the encryption of Data #34 is completed, the first sequencer 131 acquires the header of the next sector data. Before the encryption of Data #34 is completed, the common units can start the process of S12 for the next sector data. In addition, immediately after the process of S12 is completed, the common portions can start the process of S13.

In the second embodiment, at the time when the process of S12 is completed, key calculation unit #2 provided in each AES core 135 is in an idle state. After the common units complete the process of S12, key calculation unit #2 provided in each AES core 135 can start the process of S14, without waiting until the encryption of Data #34 is completed.

As such, according to the second embodiment, each AES core 135 includes two key calculation units 136. One of the two key calculation units 136 calculates an expanded key for encrypting one sector data item. Before the encryption of the last unit data in the one sector data item is completed, the other of the two key calculation units 136 starts calculation of an expanded key for encrypting the next sector data following the one sector data item. Therefore, the time from the completion of the encryption of one sector data item to the start of the encryption of the next sector data is further reduced. As a result, latency for data transmission is further reduced.

Similarly, each AES core 145 includes two key calculation units 146. One of the two key calculation units 146 calculates an expanded key for decrypting one sector data item. Before the decryption of the last unit data in the one sector data item is completed, the other of the two key calculation units 146 starts calculation of an expanded key for decrypting the next sector data following the one sector data item. Therefore, the time from the completion of the decryption of one sector data item to the start of the decryption of the next sector data is further reduced. As a result, latency for data transmission is further reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system which can be connected to a host, comprising:
a non-volatile memory; and
a controller that controls the non-volatile memory,
wherein the controller includes a first conversion unit,
the first conversion unit includes:
a first key output unit;
a plurality of first cores that perform encryption;
a first sequencer that sequentially acquires first data as a plurality of second data items with a first size and third data, causes the first key output unit to output a first key for encrypting the first data, distributes the plurality of second data items sequentially to the plurality of first cores, distributes the third data to the same first core as that to which fourth data is distributed, before the encryption of the third data is completed, starts acquiring fifth data which is received from the host following the first data, and causes the first key output unit to output a first key for encrypting the fifth data, the first data being received from the host, the third data having a second size less than the first size and being acquired last, the fourth data being acquired immediately before the third data; and
a second sequencer that collects data encrypted by each of the plurality of first cores; wherein
the controller transmits the data collected by the second sequencer to the non-volatile memory.

2. The memory system according to claim 1,
wherein each of the plurality of first cores further includes:
two first key calculation units that calculate a first expanded key on the basis of the first key; and
an encryption unit that encrypts the data distributed by the first sequencer using the first expanded key,
causes one of the two first key calculation units to calculate the first expanded key on the basis of the first key for encrypting the first data, and
causes, after the first key output unit outputs the first key for encrypting the fifth data and before the encryption of the third data is completed, the other of the two first key calculation units to calculate the first expanded key on the basis of the first key for encrypting the fifth data.

3. The memory system according to claim 1,
wherein the first key output unit outputs the first key on the basis of a first section among a plurality of sections, the first section including a logical address corresponding to the first data in an address space, the address space being divided into the plurality of sections.

4. The memory system according to claim 1,
wherein the controller includes a second conversion unit,
the second conversion unit includes:
a second key output unit;
a plurality of second cores that perform decryption;
a third sequencer that sequentially acquires sixth data as a plurality of seventh data items with a third size and eighth data, causes the second key output unit to output a second key for decrypting the sixth data, distributes the plurality of seventh data items sequentially to the plurality of second cores, distributes the eighth data to the same second core as that to which ninth data is distributed, before the decryption of the eighth data is completed, starts acquiring tenth data which is read from the non-volatile memory following the sixth data, and causes the second key output unit to output a second key for decrypting the tenth data, the sixth data being read from the non-volatile memory, the eighth data having a fourth size less than the third size and being acquired last, the ninth data being acquired immediately before the eighth data among the plurality of seventh data items; and
a fourth sequencer that collects data decrypted by each of the plurality of second cores; wherein
the controller transmits the data collected by the fourth sequencer to the host.

5. The memory system according to claim 4,
wherein each of the plurality of second cores includes:
two second key calculation units that calculate a second expanded key on the basis of the second key; and
a decryption unit that decrypts the data distributed by the third sequencer using the second expanded key,
causes one of the two second key calculation units to calculate the second expanded key on the basis of the second key for decrypting the sixth data, and causes, after the second key output unit outputs the second key for decrypting the tenth data and before the decryption of the eighth data is completed, the other of the two second key calculation units to calculate the second expanded key on the basis of the second key for decrypting the tenth data.

6. The memory system according to claim 4,
wherein the second key output unit outputs the second key on the basis of a second section among the plurality of sections, the second section including a logical address corresponding to the sixth data in the address space.

7. The memory system according to claim 1,
wherein the first data has a minimum size which can be designated by a command from the host.

8. A controller that controls a non-volatile memory, comprising:
a first conversion unit,
wherein the first conversion unit includes:
a first key output unit;
a plurality of first cores that perform encryption;
a first sequencer that sequentially acquires first data as a plurality of second data items with a first size and third data, causes directs the first key output unit to output a first key for encrypting the first data, distributes the plurality of second data items sequentially to the plurality of first cores, distributes the third data to the same first core as that to which fourth data is distributed, before the encryption of the third data is completed, starts acquiring fifth data which is received from the host following the first data, and causes the first key output unit to output a first key for encrypting the fifth data, the first data being received from the host, the third data having a second size less than the first size and being acquired last, the fourth data being acquired immediately before the third data; and
a second sequencer that collects data encrypted by each of the plurality of first cores; wherein
the controller transmits the data collected by the second sequencer to the non-volatile memory.

9. The controller according to claim 8,
wherein each of the plurality of first cores further includes:
two first key calculation units that calculate a first expanded key on the basis of the first key; and
an encryption unit that encrypts the data distributed by the first sequencer using the first expanded key,
causes one of the two first key calculation units to calculate the first expanded key on the basis of the first key for encrypting the first data, and
causes, after the first key output unit outputs the first key for encrypting the fifth data and before the encryption of the third data is completed, the other of the two first key calculation units to calculate the first expanded key on the basis of the first key for encrypting the fifth data.

10. The controller according to claim 8,
wherein the first key output unit outputs the first key on the basis of a first section among a plurality of sections, the first section including a logical address corresponding to the first data in an address space, the address space being divided into the plurality of sections.

11. The controller according to claim 8, further comprising:
a second conversion unit,
wherein the second conversion unit includes:
a second key output unit;
a plurality of second cores that perform decryption;
a third sequencer that sequentially acquires sixth data as a plurality of seventh data items with a third size and eighth data, causes the second key output unit to output a second key for decrypting the sixth data, distributes the plurality of seventh data items sequentially to the plurality of second cores, distributes the eighth data to the same second core as that to which ninth data is distributed, before the decryption of the eighth data is completed, starts acquiring tenth data which is read from the non-volatile memory following the sixth data, and causesthe second key output unit to output a second key for decrypting the tenth data, the sixth data being read from the non-volatile memory, the eighth data having a fourth size less than the third size and being acquired last, the ninth data being acquired immediately before the eighth data among the plurality of seventh data items; and
a fourth sequencer that collects data decrypted by each of the plurality of second cores; wherein
the controller transmits the data collected by the fourth sequencer to the host.

12. The controller according to claim 11,
wherein each of the plurality of second cores further includes:
two second key calculation units that calculate a second expanded key on the basis of the second key; and
a decryption unit that decrypts the data distributed by the third sequencer using the second expanded key,
causes one of the two second key calculation units
calculate the second expanded key on the basis of the second key for decrypting the sixth data, and causes, after the second key output unit outputs the second key for decrypting the tenth data and before the decryption of the eighth data is completed, the other of the two second key calculation units to calculate the second expanded key on the basis of the second key for decrypting the tenth data.

13. The controller according to claim 11,
wherein the second key output unit outputs the second key on the basis of a second section among the plurality of sections, the second section including a logical address corresponding to the sixth data in the address space.

14. The controller according to claim 8,
wherein the first data has a minimum size which can be designated by a command from the host.

15. A method of controlling a memory system that includes a non-volatile memory and can be connected to a host, comprising:
acquiring sequentially, by a first sequencer, first data as a plurality of second data items with a first size and third data, the first data being received from the host, the third data having a second size less than the first size and being acquired last;
causing, by the first sequencer, a first key output unit to output a first key for encrypting the first data;
distributing, by the first sequencer, the plurality of second data items to a plurality of first cores;
distributing, by the first sequencer, the third data to the same first core as that to which fourth data is distributed, the fourth data being acquired immediately before the third data;
encrypting, by each of the plurality of first cores, the distributed second or third data using the first key;
before the encryption of the third data is completed, starting, by the first sequencer, acquiring fifth data following the first data from the host and causing, by the first sequencer, the first key output unit to output a first key for encrypting the fifth data;
collecting, by a second sequencer, data encrypted by each of the plurality of first cores; and
transmitting, by a controller, the data collected by the second sequencer to the non-volatile memory.

16. The method according to claim 15,
wherein the encrypting includes:
calculating a first expanded key on the basis of the first key;
encrypting the data distributed by the first sequencer using the first expanded key; and
calculating the first expanded key on the basis of the first key for encrypting the fifth data after the first key output unit outputs the first key for encrypting the fifth data and before the encrypting of the third data is completed.

17. The method according to claim 15,
wherein the first key output unit outputs the first key on the basis of a first section among a plurality of sections, the first section including a logical address corresponding to the first data in an address space, the address space being divided into the plurality of sections.

18. The method according to claim 15, further comprising:
acquiring sequentially, by a third sequencer, sixth data as a plurality of seventh data items with a third size and eighth data, the sixth data being read from the non-volatile memory, the eighth data having a fourth size less than the third size and being acquired last;
causing, by the third sequencer, a second key output unit to output a second key for decrypting the sixth data;
distributing, by the third sequencer, the plurality of seventh data items sequentially to a plurality of second cores;
distributing, by the third sequencer, the eighth data to the same second core as that to which ninth data is distributed, the ninth data being acquired immediately before the eighth data among the plurality of seventh data items;
decrypting, by each of the plurality of second cores, the distributed seventh or eighth data using the second key;
before the decryption of the eighth data is completed, starting, by the third sequencer, acquiring tenth data which is read from the non-volatile memory following the sixth data, and causing, by the third sequencer, the second key output unit to output a second key for decrypting the tenth data;
collecting, by a fourth sequencer, data decrypted by each of the plurality of second cores; and
transmitting, by the controller, the data collected by the fourth sequencer to the host.

19. The method according to claim 18,
wherein the decrypting includes:
calculating a second expanded key on the basis of the second key;
decrypting the data distributed by the third sequencer using the second expanded key; and
calculating the second expanded key on the basis of the second key for decrypting the tenth data after the second key output unit outputs the second key for decrypting the tenth data and before the decrypting of the eighth data is completed.

20. The method according to claim 18,
wherein the second key output unit outputs the second key on the basis of a second section among the plurality of sections, the second section including a logical address corresponding to the sixth data in the address space.
